(19) United States
(12) Patent Application Publication
(10) Pub. No.: US 2026/0228721 A1
(43) Pub. Date: Aug. 6, 2026

(54) SECURE MAPPING OF AGGREGATED PURCHASED ITEMS TO VERIFIABLE USER IDENTITIES FOR CONSOLIDATED PICKUP AND DELIVERY

(71) Applicant: Capital One Services, LLC, McLean, VA (US)

(72) Inventors: Kevin Osborn, Newton Highlands, MA (US); Kiranjit Mand, McLean, VA (US)

(21) Appl. No.: 19/042,746

(22) Filed: Jan. 31, 2025

(51) Int. Cl. G06Q 20/38; G06Q 20/32; G06Q 20/40; H04L 9/32

(52) U.S. Cl. CPC G06Q 20/3827; G06Q 20/3276; G06Q 20/3829; G06Q 20/401; H04L 9/3213; H04L 9/3236

(57) ABSTRACT

Systems and methods are directed to secure mapping and aggregation of purchase transactions. A common identifier associated with all purchase transactions, conducted within a pre-determined time window, is generated. One example utilizes a hashed identifier generated from PAN retrieved from a user EMV transaction card. The hashed PAN identifier can be incorporated with a timestamp associated with a prescribed time window that accommodates a duration of a user shopping activity at a merchant collective. The identifier code may be replicated for retrieval of purchased items within the allotted time window using the same PAN.

### FIELD OF THE DISCLOSURE

The present disclosure is generally related to consolidation of shopping packages and delivery system, and more specifically to transactional aggregation and mapping to a secure user identity based on a payment method.

### BACKGROUND

User shopping experience at a mall or other venues associated with concentrated collection of merchants may be inhibited as each purchased item is directly released to the user upon completion of a purchase transaction hampering a user's shopping activity due to physical load associated with carrying of the purchased items. As such, there is a need for a system and process for secure consolidation of purchased items, in such environments, that may be securely released to the user at a pickup depot or consigned for later delivery. Mapping and aggregation of user purchase transactions, that is based directly on a corresponding payment card data, may be associated with privacy and security concerns and unnecessary expose of a user's sensitive data which must be re-produced again by the user at a later time to validate a pickup or delivery.

These and other deficiencies exist. As such, there is need for an improved system and process for enabling secure and seamless aggregation and mapping of transactions for consolidated pick up and/or delivery by a verifiable user.

### SUMMARY OF THE DISCLOSURE

In some aspects, the techniques described herein relate to a method for time-restricted mapping of transaction items to an anonymously verifiable user identity, the method comprising: generating, by a first device, an initial identification code by hashing a first user-related data and with an initial timestamp using a first key associated with a merchant collective, wherein the initial timestamp is associated with an initial transaction conducted by a user at a first merchant within the merchant collective, and wherein the initial identification code is reproducible for timestamps within a first valid time windows starting from the initial timestamp; generating, by the first device, a first pick-up code associated with the initial identification code, wherein the first pick-up code is provided to the user at the first merchant; transmitting the first identification code to the back-end process, wherein the first identification code identifies an item bin associated with the user; mapping one or more identification codes, generated by hashing the first user-related data with one or more timestamps within the first valid time, to the initial identification code, wherein the one or more timestamps are associated with one or more transactions conducted by the user at one or more merchants in the merchant collective; aggregating a plurality of purchased items associated with the initial transaction and the one or more transactions into the item bin, and providing the plurality of purchased items based on validating the first pick-up code within the first valid time window.

In some aspects, the techniques described herein relate to a system for providing time-restricted mapping of transaction items to an anonymously verifiable user identity, the system comprising: a first device comprising: a processor; a memory, and a first server connected to the first device via a network; wherein the first device is configured to: generate, an initial identification code by hashing a first user-related data and with an initial timestamp using a first key associated with a merchant collective, wherein the initial timestamp is associated with an initial transaction conducted by a user at a first merchant within the merchant collective, and wherein the initial identification code is reproducible for timestamps within a first valid time windows starting from the initial timestamp; generate, a first pick-up code associated with the initial identification code, wherein the first pick-up code is provided to the user at the first merchant; transmit the first identification code to the server, wherein the first server is configured to: map the first identification code, received from the first device, to a secondary identifier identifying an item bin associated with the user; map one or more dynamic codes generated by hashing the first user-related data with one or more timestamps within the first valid time, to the initial dynamic code, wherein the one or more timestamps are associated with one or more transactions conducted by the user at one or more merchants in the merchant collective; aggregate a plurality of purchased items associated with the initial transaction and the one or more transactions into the item bin, and validate the first pick-up code received within the first valid time window wherein validation of first pick-up code provides the plurality of purchased items to a user.

### BRIEF DESCRIPTION OF THE DRAWINGS

FIG. 1 illustrates a system implementation according to an example embodiment.

FIG. 2 illustrates a purchase aggregation and mapping process for EMV transactions using merchant-generated identification codes, according to an example embodiment.

FIG. 3 illustrates a purchase aggregation and mapping process for EMV transaction using system-assigned identification codes, according to an example embodiment.

FIG. 4 illustrates a switchboard implemented purchase aggregation and mapping process for EMV transaction based on an integrated contactless identity verification, according to an example embodiment.

FIG. 5 illustrates a switchboard implemented purchase aggregation and mapping process for EMV transactions featuring integrated identity verification and payment authorization, according to an example embodiment.

FIG. 6 illustrates an exemplary switchboard system implementation according to an example embodiment.

FIG. 7 illustrates a block diagram of an exemplary system according to an example embodiment.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

A general embodiment of the present disclosure is directed to systems and methods for seamless and secure aggregation of purchase transactions and consolidation of purchased items associated with a user's transactional activities within a merchant collective. Merchant collectives may correspond to a shopping mall with various merchant stores geographically situated together within a mall structure. Other geographical clustering of merchants such resort-affiliated merchant or merchants that sprout around a specific attraction such as an amusement/theme park, or a downtown shopping district may all be considered as merchant collectives, for the purposes of the present disclosure. Another example of a merchant collective may correspond to a grouping of merchant associated with a common merchandise storage and/or local depot that can be utilized for gathering of packages, corresponding to purchased items, for a later pick up by a (variable) customer and/or collective delivery of aggregated packages to a designated address associated with a user and/or customer.

A general difficulty with such systems and methods associated with anonymous collection of purchased items. from various independent merchants operating under a common geographical umbrella, is the secure and anonymous implementation of mapping mechanism between multiple merchant transactions, corresponding to multiple purchased items, and a particular user to implement secure and anonymous consolidation of the corresponding packages. Considering a starting point wherein a user indicates a desire for purchased transaction at a merchant within a merchant collective for a later pick up of the purchased packages at a time more convenient for the user, for example, at the end of a shopping trip to a mall. One way of assigning a specific transaction and a corresponding purchased item to an identifiable user is to utilize the payment credential information, such as credit card information, to create an identifier that would be used to tag and group the purchases for a later pickup or delivery to a user-provided or registered location address of the user. Under one implementation a user may register an account with the merchant collective (e.g., the mall). In this implementation a primary account number (PAN) associated with a Europay, Mastcard, and Visa (EMV) card (e.g., a credit card) may be used as a variable identifier of a user for all purchase transactions conducted with a particular EMV card within a merchant collective. However, this would approach entails exposure of sensitive payment card industry (PCI) data. Therefore, a more secure implementation is to codify such data identifier (e.g., using a hash function) into a scrambled version of the same that would be usable for just identifying the purchase transactions and hence the purchased items. If the same payment card is used for all transaction, all the transaction would be associated with the same scrambled PAN data.

The hashing and/or scrambling function may be fulfilled by a point of sale (POS) device at a checkout point of a merchant. Such POS device may require additional functionality to either separately read the payment card, retrieve the PAN data, hash the acquired data into a scrambled identification code and send this information out (e.g., via a back-door connection) to a back-end system. The back-end system would be running an identifier based aggregation routine for the received user transactions and purchased items. In another implementation the aggregation code generation (e.g., based on the hashed PAN), instead of being sent out of a back-door, may be incorporated into the purchase flow carried out by the POS device.

One impediment in way of integrating aggregation code generation functionality into a merchant POS device is that different merchants may have different corporate standards for POS implementation. Therefore, in accordance to one embodiment, POS facilitation of an aggregation code may be realized by using a standardized POS for a merchant collective (e.g., a mall reader). In this embodiment, a standardized POS device with a wireless reader may be disposed within different merchant locations. The standardized POS may then facilitate the aggregation code generation based on a tap of the payment card to retrieve and hash the PAN in order to initiate the collection of purchases by a user. In an implementation that interposes this operation into the purchase flow of the POS payment process (e.g., via a merchant acquiring bank), the PAN information is also captured and hashed by the POS device. The hashing may be performed with a timestamp as an input so that the hashed value is of limited use as an identification and authentication data feature. A time window may be associated with the timestamp such that the hashed value would not be valid outside of the associated time window. The time-limited hashed data value is then sent to a back-end system that would start accumulating the purchases.

Therefore, one embodiment of the present disclosure describes a standardized POS that retrieves the PAN, hashes the PAN into an anonymous identifier (e.g., a hash tag), and sends the anonymous (PAN) identifier it to a back-end system to be used as an index for identifying and accumulating hash-tagged purchases made by the user at different merchant locations within the merchant collective. Time data integrated into the hash tag, by the standardized POS device, sets a time-limit for the accumulated purchases, as a security feature. Aggregation of purchases may then be performed based on the time-limited hash tags generated at each standardized POS.

With regard to the standardized POS operations, a timestamp may be included into the hash tag generated from the PAN. The timestamp may be granular so that the hash tag generated from the PAN of the user would be the same from different POS devices in the pre-assigned (shopping) time window may correspond to the same code (in order to be identified and aggregated). Accordingly, hash tags generated with timestamps that are finely enumerated may not be comparable between different POS devices during a shopping time-window, as all the timestamps may not fall within the same time window. In one exemplary implementation, all the POS codes with matching time stamps are aggregated under a bin identifier. A purchased item associated with a POS-generated hashed identifier with a timestamp exceeding the shopping time-window (e.g., as determined at the first merchant associated with the first purchase transaction of the user within the merchant collective) may not be aggregated with the other user purchase transactions (e.g., corresponding to POS identifiers generated within the shopping time window).

A reverse mapping of an aggregation code (e.g., hash PAN identifier) may be performed at the pickup phase. Accordingly, during pickup or delivery authorization, another identification process must be performed at the pickup, and this identifier may be implemented via a bar code (e.g., a quick response (QR) code), that may be printed on a receipt provided by the POS device at the first merchant where a user may have initially indicated a package pickup option. The QR code represents the aggregation identifier to which various transaction codes (e.g., hashed PAN identifiers associated with different purchase transactions) are mapped. The QR code may further be mapped to another code, for example, a bin identifier code for a bin storing user's purchased products.

Another implementation may supplant the need for a physical receipt with an initial QR code, representing the aggregation code, by a tap of the user's payment card (utilized for the purchase transactions). In this implementation, a secure code initially generated by the transaction device, used for conducting the user transactions, is retrieved by a pick up reader, via a tap of the transaction card on the pickup reader, and matched to a corresponding bin.

Although there may be some advantages with having the POS generate the aggregation code (e.g., hashed PAN identifier) the problem with using strictly the POS identifier is that because the timestamp is integrated into the hash code by the POS device (e.g., when using the POS-generated identifier) the hash code cannot be recreated during at the retrieval phase by tapping the card if the retrieval/pickup time (e.g. the designated time-window) has expired. However, if the aggregation identifier is generated (e.g., based on input data common to all the transaction) by the back-end system that performs the mapping and the aggregation, an identifiers generated by a user device at the pickup (or printed as a QR code on an initial receipt) can be looked up in a database and the disposition of the packages can be determined,

Accordingly, one embodiment corresponds to the back-end system generating the hash tag from the user-provided (or user device provided) data and the POS-provided data (which in this scenario may or may not be encoded with a timestamp) instead of having each individual POS generated a timestamped transaction code. In one embodiment, with respect to the back-end generated code, an identifier, corresponding to a hashed PAN stored, for example, on a user transaction device, may be used as an authenticated identifier for the person who made the purchases, (alternatively the PAN data, retrieved via the POS device may be hashed by the back-end system). If the back-end system is creating the aggregation identifiers (e.g., based on input data common to all the transaction), the identifiers can be looked up in a database and the disposition of the packages can be determined, whether they have been moved to a back storage or not. The hashed (PAN) code may then be used as a personal identifier/authentication of the person at the pickup phase. The hashed code may be further mapped to another code which indicates a bin number for aggregating different purchased items. Other logistical codes may be provided and mapped, by the back-end system, onto the hashed PAN identifier (or other authenticated user identifiers) for implementing proper routing and management of purchased products assigned for pickup.

In some embodiment, the back-end operations (e.g., aggregating and mapping all the transactions to a user identity and generating a bin assignment for corresponding set of purchased items) may be carried out by a distributed management system with data routing and computational capabilities (e.g., cloud-based switchboard system). In this implementation instead of reading a PAN identifier form the EMV transaction card and hashing it into an anonymous identifier as an index for a designated group of aggregated transactions (e.g., designated by a time-window of occurrence), an identification code (comprising of unique card identifier) may be retrieved from a distinct contactless card associated with the user and used as the aggregation identifier. The contactless cared may correspond to a device that is distinct from the user card and/or device used for conducting the EMV transaction, or it may be the same card with added functionality for providing a NFC-transmittable encrypted identifier. For example, a transaction identifier (ID) is generated when a user payment card is read by the merchant POS device. Along with this transaction ID, a unique card identifier (pUID) may also be retrieved by the POS device and forwarded to a switchboard process. The transaction ID is then correlated with the contactless card pUID on the switchboard, and an aggregation or a pickup code uniquely associated with the user (e.g., identified from and/or mapped to the pUID of the contactless card associated with the user) is then generated. Accordingly, transaction IDs and unique card identifiers (pUID) generated and retrieved on the front end (by the POS device) are transmitted to a switchboard system which carries out the correlation, mapping, aggregation, and pickup code generation.

In one example of switchboard implementation, the payment data, associated with a payment transaction, is received via a tap of the EMV transaction card on the POS device and transmitted to a corresponding payment network for remote authorization. In conjunction with the same payment transaction a unique card identification data stored on separate contactless card associated with the user is retrieved, via a near field communication (NFC) tap on a reader of the POS device and transmitted to the switchboard system for validation and identity tokenization. During the payment transaction initiated by the EMV transaction card (e.g., during a tap of the EMV transaction card utilized by the user for payment) the POS device may also capture other transaction-related data, such as merchant identifier, transaction identifier, product identifier, etc., along with the payment data captured for transmission to a corresponding payment network. This transaction-related data is forwarded, along with the unique card identifier captured from the user contactless card (e.g., during a second tap using the contactless card on the reader of the POS device) to the switchboard system. The EMV transaction data/identifiers and the contactless card unique card identifier (pUID) are correlated by a process running as part of the switchboard system to generate a pickup code that can be identified from and/or mapped to the unique card identifier (e.g. pUID).

Accordingly, one embodiment of the present disclosure allows for a user to tap their contactless card on an NFC-capable terminal (for retrieval of unique card information) following or prior to an EMV transaction (e.g., prior to or following the initiation of a read interaction between the EMV transaction card and a POS device reader). The POS device forwards the transaction identifier (ID) along with the NFC-transmitted packet (comprising unique card information) retrieved from the contactless card to a cloud-based switchboard system. The contactless card data packet is validated by an authentication server of a corresponding issuing entity via facilitation of switchboard which can route messages from client device to various corresponding issuing parties and merchant services participating as partner services on the switchboard. Accordingly, a validation function implemented via the switchboard may generate a validation token, upon verifying the contactless card message. The validation token may then serve as an authenticated identity token computed from data securely stored onto the contactless card of the user. The switchboard process may further call a function for performing package aggregation that may be aggregated under the authenticated identity token or another code identifier mapped thereto. The aggregation process may further initiate a bucket construct for the user on a (distributed) switchboard server that is handling the aggregation function. The transaction ID retrieved from the EMV transaction would then be added to that bucket.

With respect to the aforementioned embodiment an EMV transaction IDs generated via a first tap on the POS device reader, using the payment card, is associate with the authentication packet retrieved from the contactless card via a second tap on the POS reader using the contactless user card. In some embodiments, a user may tap their contactless card, storing unique card and/or user related data, for each transaction conducted with the first payment instrument (e.g., EMV transaction card). One implementation involves generation of an initial dynamic code from unique identification data retrieved from the contactless card. The initial dynamic code may be associated with an initial timestamp and a retrieval time interval (e.g. a pick-up time window for the transacted/purchased products). Accordingly, a user may tap the contactless card for each additional purchase transaction, conducted with one or more EMV transaction cards associated with the user, to map all the transactions to the unique identification data (e.g., unique card identifier) and hence the initial dynamic code.

It is noted that in some embodiments, the mapping which takes place on the switchboard may involve a validation token instead of direct mapping onto the unique card identifier. The validation token may be generated by a corresponding validation entity that may be available as a switchboard partner service. The validation code may be generated by the corresponding validation entity upon authenticating the NFC message of the contactless card. Accordingly, the same contactless tap action, for retrieval of the card unique identifier (pUID) carried out during a pickup phase would generate the same identifier and/or validation token to which all the transaction identifiers, associated with the payment transactions conducted by the user during a designated time-window, were mapped to. Therefore, the pUID or the validation token generated therefrom would match up with all the transaction IDs.

One aspect of the present disclosure describes a system and method for integrating the POS functionality into the switchboard for enabling direct payment with the switchboard using the contactless card features and functionalities. This would remove the complications of integrating with EMV payment systems by processing all the purchase transaction through switchboard as well. In this implementation a process emulating that of the POS payment processing is executed on the switchboard. As an example, the process (corresponding to the POS function called at the switchboard) generates distinct virtual payment card numbers for each distinct merchant and charge the virtual card number via interaction with a corresponding issuing bank available as partner service on the switchboard. This implementation would bypass specific payment networks for processing of a payment transaction, as they would be interfacing with the switchboard, and this would streamline and simplify the system and user operations because both the authentication and the payment processing, as well as other ancillary services like purchase aggregation and delivery facilitation could be all tied together through orchestration of the switchboard. In that sense a user transaction at a POS device would go directly, through the switchboard, to a corresponding issuing bank. The issuing bank would then perform the user authentication and payment authorization and inform a purchase aggregation function running on the switchboard. The aforementioned implementation further simplifies the data retrieval process from a POS device. For example, the POS device generates a single transaction request based on reading a user's contactless card. The transaction request is then forwarded to the switchboard system. A unique card identifier (pUID) is extracted from the transaction request and used for authentication and generation of a validation token (e.g., for mapping and aggregation of various user purchase transactions). In conjunction with the validation process, payment credentials, included in the transmission request, are mapped to distinct virtual payment credentials, for various merchant, and routed to and authorized by a corresponding issuing partner associated with the user's payment account and/or transaction instrument.

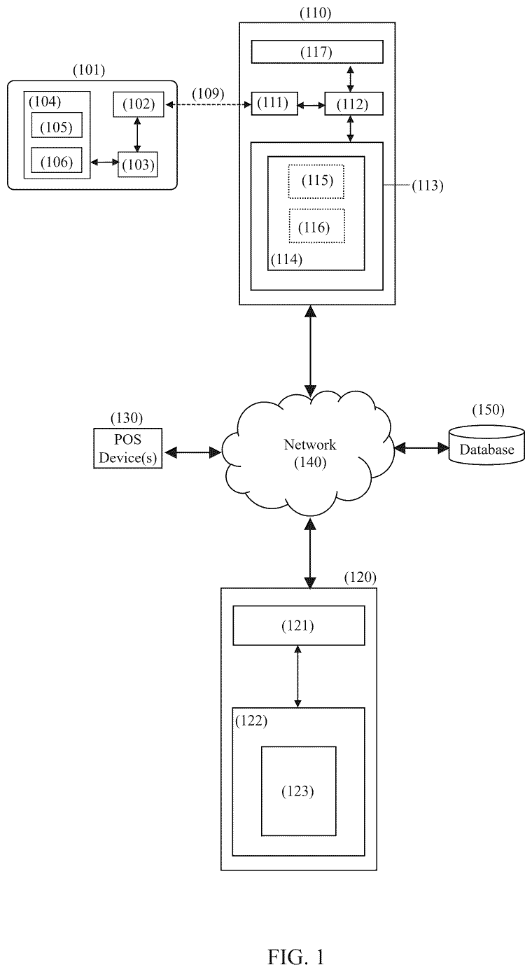

One aspect of the described process may be facilitated by the exemplary system implementation 100, illustrated in FIG. 1. Example 100, of FIG. 1, illustrates an exemplary representation of a contactless card 101 configured with an NFC interface/tag 102 and a user mobile device 110 configured with an NFC reader unit 111. The contactless card may comprise an integrated processor 103 and memory 104 that may store, for example, user and/or card identifying and/or authenticating information as near field communication (NFC) transmittable data (e.g., NFC Data Exchange Format (NDEF)). The integrated memory 104 may also store one or more applets 105 that may be communicatively coupled to one or more applications 114 running on the user mobile device 110 (e.g. NFC reading application and/or API 115 for facilitating one or more wireless reads and writes of the contactless card 101 and/or a WebNFC-based browser 116). Applet 105 may correspond to a near-field communication data exchange format (NDEF) applet storing one or more NDEF records which may be updated via an NDEF write command transmitted from the mobile communication device 110 and/or read from the contactless card via an NDEF read command transmitted from the mobile communication device 110.

The card-integrated memory may further store one or more data records 106 associated with the one or more applets 105. The card-integrated memory 104 may also include an application transaction counter (not shown) to keep track of a proper sequence of read and/or write transaction associated with the contactless card 101. The contactless card 101 may further comprise a Near Field Communication (NFC) interface and/or tag 102 to facilitate NFC communication with an NFC reader (e.g., reader unit 111 of the user mobile device 110 via NFC link 109). A contactless transaction (e.g., a read and/or write operation directed at the contactless card 101) may be facilitated by the reader unit 111 of the mobile user device 110, by bringing the contactless card within an NFC range of the mobile device (e.g., by tapping the contactless card on a reader of the user mobile device).

Memory 113 may include one or more applications 114, which with regards to user communication device, may be used for facilitating NFC-based exchange of data with an external source within an NFC field of the mobile device. Accordingly, the mobile device 110 may be configured for wireless communication with the contactless card 101 via a short-range wireless connection (e.g., NFC), and network communication, via a network 140 with one or more remote servers (e.g., server 120). The processor 112 may be a processor, a microprocessor, or other processor, and the user communication device 110 may include one or more of these processors. The processor 112 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The user communication device 110 may further include one or more input/output (I/O) devices 117 for capturing user inputs and displaying one or more information records and/or notification messages to the user. For example, I/O devices 117 may include at least one display and input device. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user (mobile) device that is available and supported by the device, such as a touch-screen, keyboard, mouse, cursor-control device, touch-screen, microphone, digital camera, video recorder or camcorder.

I/O devices 117, associated with the user device 110, may include an electronic wireless interface (e.g., reader/writer unit 111) for writing data to and capturing data from the contactless card 101 via one or more short range communications protocols such as near field communication (NFC). The user device 110 may be configured to transmit one or more read/write instruction to the contactless card 101, via NFC link 109. The user device 110 may be a network-enabled computer device, with a network communication interface. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a kiosk, or other network-enabled computing or communications devices. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. It is further understood that the user (mobile) device may be of any type of device that supports the communication and display of data and user input. The present disclosure is not limited to a specific number of user devices, and it is understood that the system 100 may include a single client device or multiple client devices.

Referring back to FIG. 1, the memory 113, of the user communication device 110, may be configured to store one or more software applications, such as applications 114, and other data, such as user's private data and financial account information. Applications 114 may comprise for example, an NFC application and/or API 115 for direct communication of data bytes with the contactless card 101. In some embodiments, applications 114 may further operate as an intermediary application for facilitating communication between server 120 (e.g., process 123) and contactless card 101 (e.g., applet 105). Applications 114, stored on user communication device 110, may further comprise a mobile browser 116 with a browser extension (e.g., WebNFC) to enable implementation of communication between the server 120 and contactless card 101 via generic NFC protocols such as a WebNFC API. The WebNFC-enabled mobile browser 116 allows a website (loaded on the user device such as the mobile device 110 and/or computing device 118) to communicate (read and/or write) with an NFC tag (e.g., NFC interface/tag 102 of contactless card 101) through the device's NFC reader (e.g., short-range wireless communication unit 111 of the mobile device 110 and/or the wireless communication unit 107 of the computing device 118), using NDEF messaging. Therefore, as described with respect to the example 100 of FIG. 1, the user device running the webNFC-based browser for communication of server-generated data to a user contactless card 101, may correspond to a user mobile device 110 (having short-range wireless communication unit 111) and/or a user computing device 118 (such as a desktop, laptop, and/or tablet) equipped with a wireless communication unit 107. This allows the described operation to take place without a specialized client application on the user device.

The server 120 may be used to facilitate operation of a back-end system for aggregation and mapping of data received from the plurality of different POS devices 130 within a merchant collective. Server 120 may be a network-enabled computer device. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a kiosk, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications comprising instructions for execution on the server 120. In some examples, the server 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display and input devices (not shown). The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the server 120 that can be available and supported by the server 120, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user devices (e.g., mobile device 110 and/or computing device 118), the server 120 and the database 150. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 120 or may be hosted externally of the server 120, such as by a server, by a cloud-based platform, or in any storage device that is in data communication with the server 120.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 101, the user device 110, the server 120, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. Additionally or alternatively, a storage arrangement can be provided separately from the computer-accessible medium, which can provide the instructions to the processing arrangement so as to configure the processing arrangement to execute certain exemplary procedures, processes, and methods, as described herein above, for example.

Therefore, one embodiment of the present disclosure describes a standardized POS (e.g., a mall reader) is used that retrieves the PAN, hashes the PAN and sends it to a back-end system to be used as an index for identifying and accumulating hash-tagged purchase transaction generated by other POS devices associated with different merchants in the merchant collective.

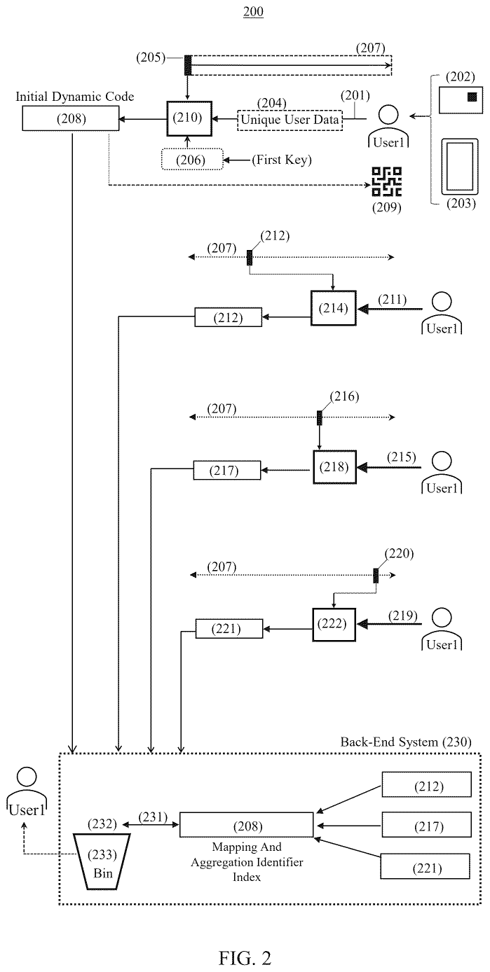

Illustrated example 200, depicts a merchant collective with 4 merchant which a user (User 1) transacts with during, for example, a shopping spree. In the example provided, the merchants are distinctly associated with standardized POS device 210 (corresponding to the first merchant and an initial user transaction), 214, 218 and 222 configured to retrieve a PAN, hash the PAN retrieved from a transaction device associated with a transacting user (e.g., User 1) and sends the hashed identifier to a back-end system 230 to be used as a mapping and aggregation index (e.g., or identifying and accumulating hash-tagged purchase transactions 2xx, 2xx, 2xx. Referring back to example 200 in FIG. 2, initially, a user (e.g. User 1) conducts an EMV transaction 201 at a POS device 210 associated with a first merchant. The user transaction 210 may be conducted with user's EMV transaction card 202 and/or a mobile communication device 203, executing, for example, one or more payment card emulation applications. Referring to example 200, wherein User 1 opts for consolidation of purchased items for later retrieval, as the EMV transaction 201 is read by the POS device 210, along with the EMV payment data, a unique identifier/identifying data 204 (e.g., a primary account number associated with EMV transaction card 202) is also retrieved by POS 210. The unique identifier data 204 is then hashed with a timestamp 205, using, for example a hash function 206 with a first key, that may be maintained and distributed by the back-end process associated with the merchant collective. With reference to example 200, the timestamp 205 is associated with a time period 207. Therefore, the generated hashed identifier (e.g., initial dynamic code 208) incorporates a timestamp associated with a time period 207, as illustrated in FIG. 2. Accordingly, for the purpose of purchased items aggregation, a time-limit corresponding to time window 207, starting at a timestamp value 205, is associated with the purchasing activities of the User 1. The initial dynamic code 208 Aggregation of purchases is performed based on the hashed identifier 208 is then sent to the back-end system used as a mapping and aggregation index for subsequent transactions 211, 215 and 219 conducted respectively at merchant POS 214, 218 and 222. Since transactions 211-219 are conducted with a same payment instrument (e.g., EMV transaction card 202, using a same PAN identifier 201), as long as corresponding transaction timestamps 212, 216, 230 fall within a certain time window (e.g., time window 207) the resulting hashed identifier 212, 217 and 221 would be mapped to the hashed identifier generated by POS 210 at the first merchant (e.g., initial dynamic code 208).

Referring back to FIG. 2, purchase transactions conducted by User1 with EMV transaction card 202 at different merchants corresponding to purchase transactions 211, 215, 220, conducted at merchant POS devices 214, 2189, 22, are associated with timestamps 212, 216, 220, all of which fall within the designated time window 207. Time window 207 may be designated, for example, during a user transaction 204 at a first merchant (e.g., POS 210). Accordingly, transactions 211, 251, 219 are mapped to the initial transaction 201 and purchased items associated with each transaction 201, 211, 215 and 219 are aggregated together in a common bin associated with User 1.

The initial dynamic code 208 upon reception by the Back-end system 230 may be mapped, by the back-end process 231, to a bin identifier 232 associated with a bin construct 233 which may be generated by a process executing on the back-end system. Purchased items associated with all transactions (e.g., 201, 211, 215, 219), upon validation by corresponding financial entity, are aggregated within the bin construct 233 associated with user 1. According to the exemplary reference in FIG. 2, a purchased item associated with a POS-generated hashed identifier with a timestamp that exceed time window 207 may not added to bin construct 233 (e.g., not aggregated with the other POS transactions).

A Reverse Mapping of bin identifier 232 back onto the initial dynamic code 208 (e.g., hashed and timestamped PAN identifier generated by POS 210) is performed at Pick-Up time. Therefore, User 1 produce a valid identifying code at pickup time. One implementation of a valid identifying code may be bar code (e.g., a QR code 209) representing the initial dynamic code 208. The QR code 209 may be generated by POS 210, along with the initial hashed identifier 208 which is sent to the back-end, and printed on a receipt provided to the user at the first merchant (e.g., where a user may have initially indicated a package pickup option). The QR code would then represent an aggregation identifier to which all the POS-generated transaction codes (e.g., 212, 217, 221), including the initial dynamic code 208, are mapped. Another form of valid identification code, which does not involve a physical receipt with an initial QR code print, may be provided by tapping the EMV transaction card 202 at a pickup reader to re-generate the initial dynamic code 208 that was generated by the POS device 210 at the first merchant (e.g., by using the same hash function 206 using the same firs key). The Bin identifier 232 for bin assignment 233 comprising the purchased items of the user is then provided in response to the card tap at the pickup reader. However, as described with respect to some embodiments, if the predetermined time interval 270 is expired at the time of pick up, the generated pickup code, by the EMV transaction card 202, may not match the aggregation code (i.e., initial dynamic code 208).

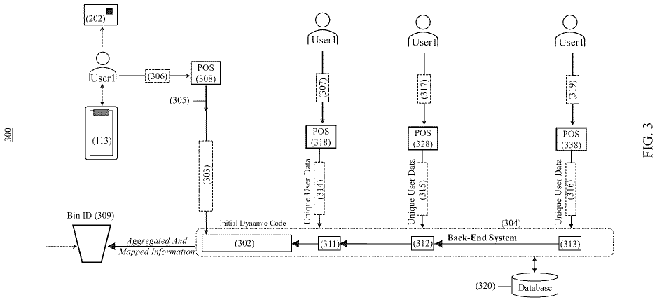

As described above, with respect to Fog. 2, due to the timestamp being integrated into the hashed code generated by the POS devices, a pickup code (generating from same input identifying input data, such as PAN) cannot be recreated at the retrieval phase (for e.g., by tapping the EMV transaction card used for the purchases, or scanning a QR code obtained at the first merchant) if the retrieval/pickup time (e.g. the designated time-window) has expired. However, a system-assigned identifiers (e.g., aggregation identifier generated by a back-end system based on input data common to all the transaction), may not be associated with a same restrictive condition, as provided by exemplary embodiment 300, illustrated in FIG. 3.

In example 300, instead of having a POS generate a timestamped aggregation code (e.g., initial dynamic code 208), the aggregation code 302 is generated by a back-end process 304. One embodiment corresponds to a back-end system running a back-end process 304 for generation of an aggregation code (e.g., hashed identifier 302) from the user-provided (or user device provided) data 306 and the POS-provided data 305 (e.g., transaction ID, product identifier, etc) which may be sent to the back-end system, as represented by initial data message 303, from a first transacting POS device 308. In one embodiment, with respect to the back-end generated aggregation code, an identifier, corresponding to a hashed PAN stored, for example, on a user transaction device, may be used as a sort of authenticated identifier for the person who made the purchases, (alternatively the PAN data, retrieved via the POS device may be hashed by the back-end system). If the back-end system is creating the aggregation identifiers (e.g., based on input data common to all the transaction), The hashed PAN may be used as a personal identifier/authentication of the person at the pickup phase. Accordingly, system-assigned purchase identifiers 311, 312, 313, associated with transaction/user related data 314, 315, 316 received from POS device 318, 328, 338 (involved in purchase transaction conducted by a transaction device of User 1) including initial data message 303 received from the initial transaction POS device 308 can be mapped to the same aggregation code 302. With respect to the exemplary embodiment 300, the relevant mapping/aggregation and/or product disposition information, may be look up in a database 320 that may be supplemented with additional data regarding a location or current disposition of purchased products (e.g., if they have been moved to a back storage or warehouse). Referring back to example 300, the hashed aggregation code 302 is further mapped to a bin identifier 309 for aggregating different purchased items (e.g., associated with user transaction requests 306, 307, 317 and 319). Other logistical codes may be provided and mapped onto the hashed PAN identifier (or other authenticated user identifiers) for implementing proper routing and management of purchased products assigned for pickup.

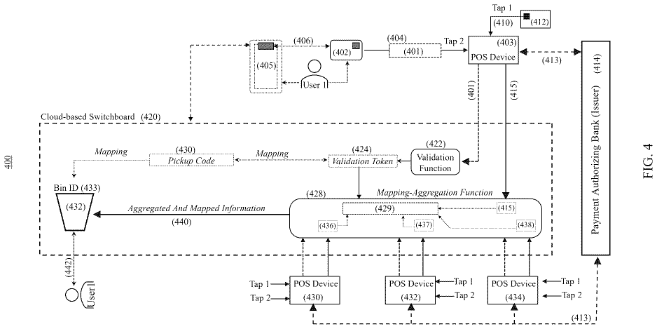

As described above back-end operations (e.g., aggregating and mapping purchase transactions and generating a bin assignment for corresponding set of purchased items) may be carried out by a distributed management system with data routing and computational capabilities (e.g., cloud-based switchboard system). Accordingly, one aspect of the present disclosure is directed to a switchboard implementation of mapping and aggregation operations (involving EMV transactions) in a secure and seamless manner. In this implementation an input data value for generation of an aggregation identifier may correspond to a secure identification data element uniquely associated with a user. On example of a such secure identification data element may correspond to a unique card identification data 401 that may be stored on and retrieved from a distinct contactless card 402 associated with the User 1. In some embodiments, unique card identifier data 401 may be communicated to the POS device 403 via an intermediary user device (user mobile communication device 405) with NFC connectivity 406 with the contactless card 402. An exemplary implementation is illustrated in FIG. 4.

In the exemplary switchboard implementation 400 illustrated in FIG. 4, EMV Payment data 408, associated with a EMV payment transaction 410, is received via a tap of the EMV transaction card 412 on the POS device 403 and transmitted to a corresponding payment network (e.g., represented by data path 413 in FIG. 4) for remote authorization by one or more account issuing entities 414. In conjunction with the same payment transaction 410 a unique card identification data 401 stored on separate contactless card 402 associated with the user (e.g., User 1) is retrieved, via a NFC tap (e.g. Tap 2) of the card 402 on a reader of the POS device 403, and transmitted to a switchboard system 418 for validation and identity tokenization. The contactless card data packet 404 (e.g., comprising the unique card identification data 401) is validated by an authentication server of a corresponding issuing entity via facilitation of switchboard (e.g., as represented by validation function 422 which can route messages from a client device to various corresponding issuing parties and merchant services participating as partner services on the switchboard.) Accordingly, a validation function 422 implemented via the switchboard 420 may generate a validation token 424, upon verifying the contactless card message 404 or the unique card identifier 401 encapsulated therein. The validation token 424 may then serve as an authenticated identity token computed from data (pUID 401) securely stored onto the contactless card 402 of the User 1.

Referring back to example 400 in FIG. 4, during the payment transaction 410 initiated by the EMV transaction card 412 (e.g., during a tap of the EMV transaction card utilized by the user for payment, represented in FIG. 4 as Tap 1) the POS device 403 may also generate other transaction-related data 415, such as merchant identifier, transaction identifier, product identifier, etc., along with the payment data captured for transmission to a corresponding payment network 413. This transaction-related data 415 is forwarded, along with the unique card identifier 401 captured from the user contactless card 402 (e.g., during a second tap using the contactless card on the reader of the POS device) to the switchboard system 420. The EMV transaction data/identifiers 415 and the contactless card unique card identifier 401 (e.g. pUID) are correlated by a process 428 running as part of the switchboard system to generate a aggregation code 429 that can be identified from and/or mapped to the unique card identifier (e.g. pUID) or to the validation token 424 generated by validating the unique card identifier 401 through a switchboard validation function 422. In some embodiment the aggregation code 429 may be further mapped to a pick-up code 430 that is verified to allow a user to access a bin (e.g., bin 432).

The switchboard process may further call a function for performing package aggregation that may be aggregated under the authenticated identity token or another code identifier mapped thereto. The aggregation process may further initiate a bucket construct 432 for the User 1 on a (distributed) switchboard server that is handling the aggregation function 428. The transaction IDs 415 retrieved from the EMV transaction 410 would then be added to the bucket construct 432.

Accordingly, with reference to the aforementioned exemplary embodiment 400, an EMV transaction ID(s) 415 generated via a first tap (e.g. Tap 1) on the POS device reader, using the EMV payment card 415, is correlated with the authentication packet (404) retrieved from the contactless card 402 via a second tap (e.g., Tap 2) on the POS reader 403 using the contactless card 402. In some embodiments, a user may tap their contactless card 402, storing unique card and/or user related data 401, for each transaction conducted with the first payment instrument (e.g., EMV transaction/payment card 412). This is represented by Tap 1 and Tap 2 operations applied to each of POS devices 430, 432 and 434. This would result in the aggregation code 429 generated from the unique identification data (e.g., unique card identifier 401) retrieved from the contactless card (or from the validated token 424 representing a pre-authenticated unique card identifier) to be associated with all the EMV transactions conducted, for example via Tap 1, at POS devices 403, 430, 432 and 434.

Accordingly, a user may tap the contactless card (e.g., Tap 2 applied to POS device 403 430, 432 and 434) for each additional EMV purchase transaction conducted with other merchants with payment card 412 (e.g., represented as Tap 1 applied to POS devices 403, 430, 432 and 434), to map relevant transaction data 415, 436, 437, 438, to the appropriate aggregator identifier associated with the unique identification data (e.g., unique card identifier) and/or the validation token generated therefrom. The aggregated and mapped information 440 (e.g., corresponding to purchase activity of User1) is then provided to the user bin 432 associated with a bin identifier 433. It is noted that in some embodiments, the mapping which takes place on the switchboard may involve the validation token 424 instead of direct mapping onto the unique card identifier 401. As described above, the validation token may be generated by a corresponding validation entity that may be available as a switchboard partner service. Accordingly, the contactless tap action 442, performed during a pickup phase for retrieval of the card unique identifier (pUID) would generate a (pickup) validation code matching the validation token 424 to which all the transaction identifiers 415, 436, 437 and 438, are mapped. In some embodiments, the validation token at pickup time may be generated by reading and transmitting identification data on the contactless card 402, by the user mobile device 405 with a reader unit 407 and transmitting it to an authentication server on the switchboard for validation and generation of the (pickup) validation token.

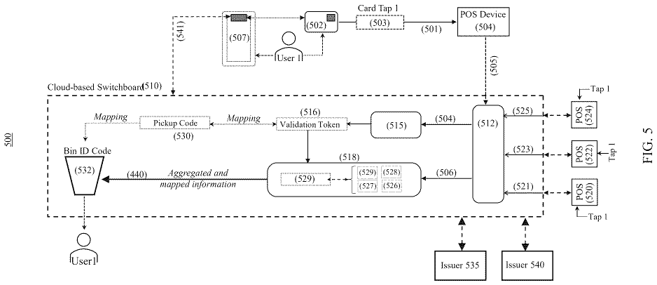

One aspect of the present disclosure describes a system and method for integrating secure and verifiable purchase aggregation and purchase payment processing functionality of a POS device into the switchboard system. Accordingly, exemplary system implementation 500, illustrated in FIG. 5, provides a switchboard implementation of direct payment processing/validation as well as ancillary services such as transaction mapping and verifiable purchase aggregation, from various merchants within a merchant collective, for consolidated pick and/or delivery, using the contactless card features and functionalities. In this way, transaction request/response messages are routed between merchant POS systems and corresponding Issuing entities via the switchboard, thus implementing direct payment functionality and identity validation into a switchboard (e.g., switchboard 510) removing the complications arising from integration with EMV payment systems and networks.

Referring back to the exemplary implementation 500, a process 512 emulating that of the POS functionality is executed on the switchboard 510. a single transaction request 505 generated, by the POS device 504, based, for example, on an NFC read a user's contactless card 502. The transaction request 505 may comprise both card-transmitted data, such as a unique card identifier 503 contained, for example, a wireless purchase transaction request 501 received from the user's contactless card 502 via NFC, as well as POS-generated transaction data such a merchant and/or a product ID associated with the wireless purchase request 501. Transaction request 505 is then forwarded to the switchboard system 510. In the exemplary implementation 500, a POS payment processing function receives the transaction request 505. Switchboard POS process 520 may then generates distinct virtual payment card numbers, based on payment credentials included in the transaction request 505, for each distinct merchant. The virtual payment card number is then charged with a transaction amount via interaction of the switchboard process 512 with a corresponding issuing bank(s) available as partner service on the switchboard (e.g., issuing entities 535, 540). This implementation would bypass specific payment networks for processing of EMV payment transaction, as various account issuing entities would be interfacing with the switchboard—This would streamline and simplify the system and user operations because ancillary services such as purchase mapping and aggregation (518) and delivery facilitation can be tied together with user authentication (e.g., via validation function 515) and the payment processing (e.g., via switchboard process 512) through orchestration of the switchboard 510. With reference to the exemplary embodiment 500, user authentication may be initiated by validation function 515 which receives a unique identifier 503 associated with User 1 and authenticates the identifier 503 via interactions with one or more partner validation service providers, such as issuing entity 520 and/or 520. The unique user identifier 503 may be provided by User 1 and/or retrieved from a device associated with user 1 (e.g., contactless card 502 and/or mobile communication device 507).

The aforementioned implementation further simplifies the data retrieval process from a POS device (e.g. POS device 504). For example, the POS device 504 generates a single transaction request 505 in response to a wireless purchase transaction request 501 received from the user's contactless card 502 via NFC. The purchase request 501 may comprise a unique card identifier 50 stored on the contactless card 502 as well as POS-generated transaction data such a merchant and/or a product ID associated with the wireless purchase request 501. The transaction request 505 is then forwarded to the switchboard system 510. A unique identifier (e.g., 503) associated with the contactless card 502 is extracted from the transaction request 505, by a receiving process on the switchboard 510 and forwarded to a switchboard validation function 515 for authentication and generation of a validation token 516, while payment credentials, included in the transmission request 505, are mapped to distinct virtual payment credentials for various merchant (e.g., by the switchboard integrated function 512), and routed to and authorized by a corresponding issuing partner (e.g., validation partner services 535, 540) associated with the user's payment account and/or transaction instrument. The validation token 516 may be used for mapping and aggregation of various user purchase transaction requests 505, 521, 523, 525, all of which will contain a unique card identifier provided by the contactless card via an NFC tap of the contactless card 502 on a reader of respective POS device (e.g., referenced as Tap 1 applied to POS devices 504, 520, 522, and 524)

In the exemplary implementation 500, in response to user transaction requests 505, 521, 523, 525, (e.g., initiated via a card tap Tap 1 of the contactless card 502 at each respective POS device 504, 520, 522, 524) POS-generated data 506 (e.g., transaction identifier, product identifier, etc.) along with unique card identifier data 503, is provided to the switchboard by each transaction request receiving POS device (namely the initial POS device 504 at a first merchant, along with POS device 250, 2562 and 254 associated with other merchant transactions conducted by User 1, at the merchant collective. Example 500 further illustrates transaction data 526-529, corresponding to POS-generated data captured from transaction requests 505, 521, 523 and 524 generated respectively by POS device 504, 520, 522, 524, being mapped to the aggregation code 529 generated from a validated identity token (e.g., as provided by a switchboard validation function 515). The aggregated information is mapped to the aggregation code 529. The aggregation code 529 may be further mapped to a pickup code 530 associated with a bin construct 532 linked to User 1 via the validation token 516.

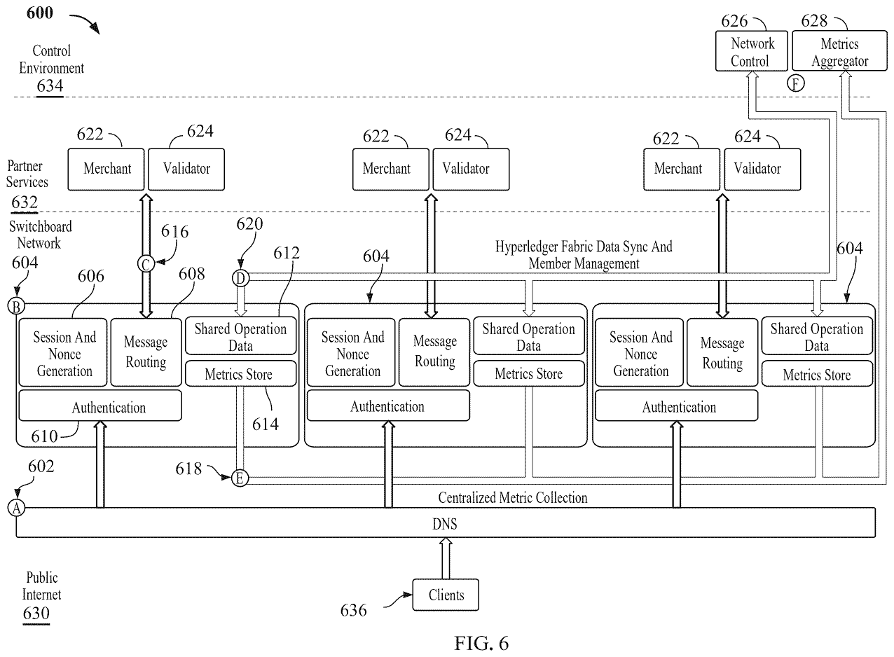

In some embodiments, the transaction request (e.g., transaction request 505, may be generated and transmitted to the switchboard by the user device 507. In such implementation, user device 507 may interact with the POS 504, on one end, to retrieve POS-provided data (e.g., transaction identifiers, product name and/or product ID, merchant identifier, etc.) and the contactless card 502, on the other, to retrieve card-transmitted data 501/503. The card-transmitted data and the POS-generated data may then be included in transaction request 541 that is then forwarded to the switchboard system 510 (as represented by data path 541) and routed there through to the appropriate validator for authentication and aggregation. An exemplary switchboard implementation is illustrated in FIG. 6.

FIG. 6 illustrates an example of a switchboard-based system 600 in accordance with the embodiments discussed herein. The system 600 includes additional devices and systems configured to enable identity validation, EMV payment validation and purchase mapping and aggregation as well as bin assignment services to one or more service requesting and/or client entities 636. Specifically, system 600 enables any number of issuer systems to provide identity validation and payment processing services to their clients through a switching fabric, i.e., the switchboard system in a secure and safe manner.

In some embodiments, the switchboard system includes one or more nodes 604 configured to perform routing operations. Each switchboard node 604 may include a session and nonce generator 606, a message router 608, an authentication function 610, an operation data 612 store, and a metrics store 614. Further, each of the nodes may be configured the same and share configurations, but each switchboard node 604 may independently process and route messages and requests to the appropriate systems. Each of the nodes 604 is configured to act as a broker of trust between an client device 636, merchant system 622, and/or validation system 624, for example. Each switchboard node 604 is configured to route each message to the correct issuer system while maintaining data security. For example, a switchboard node 604 may route a message between an issuer system and client device (e.g., using specific data fields for the unique card identifier (pUID) and the issuer identifier (pIssuerID) while the node is not able to gain access to the private data in the message.

The switchboard system may be configured as a server system including a collection of hardware, software, and networking components that work together to provide services to the clients. Hardware components may include one or more server computers, storage devices, and network adapters. The server computers are configured to run server applications, such as those executable on each of the nodes 604. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 604 may operate in a cloud-based computing environment, e.g., a collection of hardware, software, and networking components that enable the delivery of cloud computing services. The switchboard nodes 604 and the computing services are delivered over the Internet, and they can be accessed from anywhere in the world with an Internet connection. In embodiments, a client 636 may access a switchboard node 604 through Domain Name System 602 or domain name system (DNS). The DNS 602 a hierarchical and distributed naming system for computers, services, and other resources connected to the Internet or other networks. It associates various information with domain names assigned to each registered participant. In one example, the DNS 602 may translate a name known to software executing on a client 636 to route data to one or more of switchboard node 604 of the switchboard system. In embodiments, the DNS 602 may generate into a number, such as an Internet Protocol (IP) address, an address record (A-record), or another Host name (C-name record). At a high level, the Domain Name System 602 translates known domain names to numerical Internet Protocol (IP) addresses needed for locating and identifying computer services and devices with the underlying network protocols.

In embodiments, a client 636 communicates with the switchboard system to perform one or more of the partner services 632. Once the client 636 identifies a switchboard node 604 and resolves an address to communicate with the switchboard node 604, the client 636 may send one or more messages to the switchboard node 604 to authenticate and perform one-or more operation. The switchboard node 604 includes an authentication 610 function that is configured to authenticate the client 636. In embodiments, the client 636 sends a message or authorization request to the switchboard node 604 based on a data frame which utilized one or more data field to appropriately route a message through the switchboard system to perform the various operations.

The switchboard node 604 may authorize or authenticate the client 636 or user, and the switchboard node 604 may utilize the additional components, such as the session and nonce generator 606 and message router 608, to perform control operations associated, for example, with configuring an operation of a client device (e.g., contactless card). Note the clients 636 may never directly interact with the validator and/or merchant systems, nor vice versa. The nodes 204 brokers all communication.

In embodiments, the switchboard system may utilize a hyperledger fabric 620 to manage synchronizing the shared operation data 612 and member management across the network. The hyperledger fabric 620 is distributed ledger framework having a permissioned network model that only authorized participants can join the network and access the data that is stored on a ledger.

In embodiments, the hyperledger fabric 620 may be generated by creating one or more set of peers, an ordering service, and a channel. Once the network is created, the system 600 deploys chaincode to the network or nodes 604 permitted to access the fabric. The chaincode is the code that runs on the blockchain and executes the network control 626 and operation data 612 logic code. Once the chaincode is deployed, each of the switchboard nodes 604 is configured to invoke transactions on the blockchain to add data to the blockchain, e.g., the operational data. A switchboard node 604 or another device can query the ledger to retrieve data. The ledger is a distributed database that stores all of the data that has been added to the blockchain.

All nodes 604 keep an independently verifiable log of their actions that can be transmitted to a centralized aggregator to build a picture of overall network usage. At a central level, system 600 can manage network operation data and management and have a centralized view of network use, aggregated and abstracted to the appropriate level.

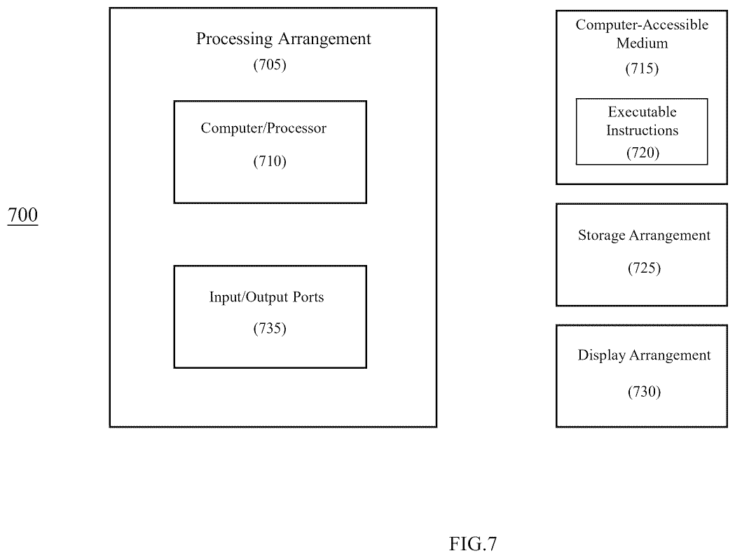

FIG. 7 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 705) may be configured for computing a trajectory of the contactless card within an optical field of view generated by a camera unit of user device and projecting a final placement of the contactless against a reader unit of the user device at a point at which the camera feed goes dark). Such processing and/or computing arrangement 705 can be, for example entirely or a part of, or include, but not limited to, a computer and/or processor 710 that can include, for example one or more microprocessors, and use instructions stored on a computer-accessible medium (e.g., RAM, ROM, hard drive, or other storage device).

As shown in FIG. 7, for example a computer-accessible medium 715 (e.g., as described herein above, a storage device such as a hard disk, floppy disk, memory stick, CD-ROM, RAM, ROM, etc., or a collection thereof) can be provided (e.g., in communication with the processing arrangement 705). The computer-accessible medium 715 can contain executable instructions 720 thereon. In addition or alternatively, a storage arrangement 725 can be provided separately from the computer-accessible medium 715, which can provide the instructions to the processing arrangement 705 so as to configure the processing arrangement to execute the exemplary procedures, processes, and methods, as described herein above, for example.

Further, the exemplary processing arrangement 705 can be provided with or include an input and/or output ports 735, which can include, for example a wired network, a wireless network, the internet, an intranet, a data collection probe, a sensor, etc. As shown in FIG. 7, the exemplary processing arrangement 705 can be in communication with an exemplary display arrangement 730, which, according to certain exemplary embodiments of the present disclosure, can be a touch-screen configured for inputting information to the processing arrangement in addition to outputting information from the processing arrangement, for example. Further, the exemplary display arrangement 730 and/or a storage arrangement 725 can be used to display and/or store data in a user-accessible format and/or user-readable format.

Systems and methods described herein can provide a system and configuration for performing an optimal NFC read of a contactless card by a reader device. Once a NFC link is established the wireless connectivity between the contactless card and the reader can permit, without limitation, financial transactions (e.g., credit card and debit card transactions), account management transactions (e.g., card refresh, card replacement, and new card addition transactions), membership transactions (e.g., joining and departing transactions), point of access transactions (e.g., building access and secure storage access transactions), transportation transactions (e.g., ticketing and boarding transactions), and other transactions.

In some aspects, the techniques described herein relate to a method of providing time-restricted mapping of transaction items to an anonymously verifiable user identity, the method comprising: generating, by a first device, an initial identification code by hashing a first user-related data and with an initial timestamp using a first key associated with a merchant collective, wherein the initial timestamp is associated with an initial transaction conducted by a user at a first merchant within the merchant collective, and wherein the initial identification code is reproducible for timestamps within a first valid time windows starting from the initial timestamp; generating, by the first device, a first pick-up code associated with the initial identification code, wherein the first pick-up code is provided to the user at the first merchant; transmitting the first identification code to the back-end process, wherein the first identification code is mapped to a secondary identifier identifying an item bin associated with the user; mapping one or more identification codes generated by hashing the first user-related data with one or more timestamps within the first valid time, to the initial identification code, wherein the one or more timestamps are associated with one or more transactions conducted by the user at one or more merchants in the merchant collective; aggregating a plurality of purchased items associated with the initial transaction and the one or more transactions into the item bin, and providing the plurality of purchased items based on validating the first pick-up code within the first valid time window. Other technical features may be readily apparent to one skilled in the art from the following figures, descriptions, and claims.

In some aspects of the described method the first identification code is mapped to a secondary identifier identifying the item bin using the first key. In some aspect the first user-related data correspond to a first account information retrieved from a first payment instrument used at the first merchant and each of the one or more merchant, wherein the initial identification code is generated by hashing a first user-related data and with an initial timestamp using a first key associated with a merchant collective. In some embodiments the registered user address is provided by a user during a registration process with the merchant collective.

In some aspect of the described method a bin identifier code, for identifying the item bin, is mapped to the initial identification code. In some aspect the first pick-up code corresponds to a quickly readable (QR) code printed on a first receipt generated by the first device for the user, wherein the QR code is attached to each of the plurality of purchased items.

In some aspects of the described method, the initial identification code is generated by the back-end process from the first user-related data using a first key. The back-end system further attaching one or more data records to the item bin for validating the first pick-up code outside of the first valid time window, wherein the one or more data records identify a disposition of the plurality of purchased items outside of the first valid time window.

In some aspects of the described method, the back-end process is implemented with a switchboard, and wherein the first user-related data for generating the initial identification code and the one or more identification codes correspond to a unique identifier retrieved from a contactless card associated with the user. In such a case the initial identification code is generated by the switchboard based on a validation token generated by validating the first user-related data via switchboard-facilitated communication with a corresponding validation entity. The first user-related data for generating the initial identification code and the one or more identification codes may correspond to a unique identifier retrieved from a contactless card associated with the user, and the validation token may be mapped to the initial transaction conducted at the first merchant and the one or more transaction conducted at the one or more merchants in the merchant collective. Accordingly, in some embodiments the validation tokens are generated for the one or more transactions conducted by the user at the one or more merchants, from the unique identifier retrieved from the contactless card during each of the one or more transactions including the initial transaction conducted at the first merchant, wherein the aggregating of the plurality of purchased items into the bin is based on a matching validation code associated with the one or more transactions including the initial transaction.

In some aspects, the techniques described herein relate to a system for providing time-restricted mapping of transaction items to an anonymously verifiable user identity, the system comprising: a first device comprising: a processor; a memory, and a first server connected to the first device via a network; wherein the first device is configured to: generate, an initial identification code by hashing a first user-related data and with an initial timestamp using a first key associated with a merchant collective, wherein the initial timestamp is associated with an initial transaction conducted by a user at a first merchant within the merchant collective, and wherein the initial identification code is reproducible for timestamps within a first valid time windows starting from the initial timestamp; generate, a first pick-up code associated with the initial identification code, wherein the first pick-up code is provided to the user at the first merchant; transmit the first identification code to the server, wherein the first server is configured to: map the first identification code, received from the first device, to a secondary identifier identifying an item bin associated with the user; map one or more identification codes generated by hashing the first user-related data with one or more timestamps within the first valid time, to the initial identification code, wherein the one or more timestamps are associated with one or more transactions conducted by the user at one or more merchants in the merchant collective; aggregate a plurality of purchased items associated with the initial transaction and the one or more transactions into the item bin, and validate the first pick-up code received within the first valid time window wherein validation of first pick-up code provides the plurality of purchased items to a user.

In some aspects, the first server of the system is further configured to assign the plurality of the purchased items for delivery to a registered address, upon validating the first pick-up code within the first valid time window. The first server may be further configured to receive the first user-related data and the initial timestamp data from the first device and generate the initial identification code from the received data using a first key. In some aspects, the first server is further configured to attach one or more data records to the item bin and validate the first pick-up code outside of the first valid time window, based on the one or more data record, wherein the one or more data records identify a disposition of the plurality of purchased items outside of the first valid time window.

Other technical features may be readily apparent to one skilled in the art from the following figures, descriptions, and claims.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

As used herein, the term “bank” is not limited to a particular bank or type of bank. Rather, it is understood that the present disclosure includes any type of bank or other business involved in activities where products or services are sold or otherwise provided.

As used herein, the term “merchant” is not limited to a particular merchant or type of merchant. Rather, it is understood that the present disclosure includes any type of merchant, vendor, or other entity involved in activities where products or services are sold or otherwise provided.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

The present disclosure includes example embodiments using NFC for contactless card communication, but it is understood that the present disclosure is not limited to a particular type of communication. Rather, the present disclosure encompasses other types of contactless card communication, such as Bluetooth, RFID, and Wi-Fi, along with NFC.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for time-restricted mapping of transaction items to an anonymously verifiable user identity, the method comprising:
generating, by a first device, an initial identification code by hashing a first user-related data and with an initial timestamp using a first key associated with a merchant collective, wherein the initial timestamp is associated with an initial transaction conducted by a user at a first merchant within the merchant collective, and wherein the initial identification code is reproducible for timestamps within a first valid time windows starting from the initial timestamp;
generating, by the first device, a first pick-up code associated with the initial identification code, wherein the first pick-up code is provided to the user at the first merchant;
transmitting the first identification code to a back-end process, wherein the first identification code identifies an item bin associated with the user;
mapping one or more identification codes generated by hashing the first user-related data with one or more timestamps within the first valid time, to the initial identification code, wherein the one or more timestamps are associated with one or more transactions conducted by the user at one or more merchants in the merchant collective;
aggregating a plurality of purchased items associated with the initial transaction and the one or more transactions into the item bin; and
providing the plurality of purchased items based on validating the first pick-up code within the first valid time window.

2. The method of claim 1, wherein the first identification code is mapped to a secondary identifier identifying the item bin using the first key.

3. The method of claim 1, wherein the first user-related data correspond to a first account information retrieved from a first payment instrument used at the first merchant and each of the one or more merchant.

4. The method if claim 3, wherein the initial identification code is generated by hashing a first user-related data and with an initial timestamp using a first key associated with a merchant collective.

5. The method of claim 4, wherein the registered user address is provided by a user during a registration process with the merchant collective.

6. The method of claim 1, wherein a bin identifier code, for identifying the item bin, is mapped to the initial identification code.

7. The method of claim 1, wherein the first pick-up code corresponds to a quickly readable (QR) code printed on a first receipt generated by the first device for the user.

8. The method of claim 7, wherein the QR code is attached to each of the plurality of purchased items.

9. The method of claim 1, wherein the initial identification code is generated by the back-end process from the first user-related data using a first key.

10. The method of claim 9, further comprising attaching one or more data records to the item bin for validating the first pick-up code outside of the first valid time window.

11. The method of 10, wherein the one or more data records identify a disposition of the plurality of purchased items outside of the first valid time window.

12. The method if claim 1, wherein the back-end process is implemented with a switchboard, and wherein the first user-related data for generating the initial identification code and the one or more identification codes correspond to a unique identifier retrieved from a contactless card associated with the user.

13. The method of claim 12, wherein the initial identification code is generated by the switchboard based on a validation token generated by validating the first user-related data via switchboard-facilitated communication with a corresponding validation entity.

14. The method of claim 13 the validation token is mapped to the initial transaction conducted at the first merchant and the one or more transaction conducted at the one or more merchants in the merchant collective.

15. The method of claim 13, wherein one or more validation tokens are generated for the one or more transactions conducted by the user at the one or more merchants, from the unique identifier retrieved from the contactless card during each of the one or more transactions including the initial transaction conducted at the first merchant, wherein the aggregating of the plurality of purchased items into the bin is based on a matching validation code associated with the one or more transactions including the initial transaction.

16. The method of claim 15, wherein a validation token generated in relation to each of the plurality of purchased items is based on validating the unique identifier retrieved from the contactless card during the first valid time window.

17. A system for providing time-restricted mapping of transaction items to an anonymously verifiable user identity, the system comprising:
a first device comprising:
a processor;
a memory, and
a first server connected to the first device via a network;
wherein the first device is configured to:
generate, an initial identification code by hashing a first user-related data and with an initial timestamp using a first key associated with a merchant collective, wherein the initial timestamp is associated with an initial transaction conducted by a user at a first merchant within the merchant collective, and wherein the initial identification code is reproducible for timestamps within a first valid time windows starting from the initial timestamp,
generate, a first pick-up code associated with the initial identification code, wherein the first pick-up code is provided to the user at the first merchant,
transmit the first identification code to the server,
wherein the first server is configured to:
map the first identification code, received from the first device, to a secondary identifier identifying an item bin associated with the user;
map one or more identification codes generated by hashing the first user-related data with one or more timestamps within the first valid time, to the initial identification code, wherein the one or more timestamps are associated with one or more transactions conducted by the user at one or more merchants in the merchant collective;
aggregate a plurality of purchased items associated with the initial transaction and the one or more transactions into the item bin, and
validate the first pick-up code received within the first valid time window wherein validation of first pick-up code provides the plurality of purchased items to a user.

18. The system of claim 16, wherein the first server is further configured to assign the plurality of the purchased items for delivery to a registered address, upon validating the first pick-up code within the first valid time window.

19. The system of claim 16, wherein the first server is further configured to receive the first user-related data and the initial timestamp data from the first device, and generate the initial identification code from the received data using a first key.

20. The system of claim 19, wherein the first server is further configured to attach one or more data records to the item bin and validate the first pick-up code outside of the first valid time window, based on the one or more data record, wherein the one or more data records identify a disposition of the plurality of purchased items outside of the first valid time window.
